(19) United States
(12) Patent Application Publication
(10) Pub. No.: US 2023/0404285 A1
(43) Pub. Date: Dec. 21, 2023

(54) Sauna Seat

(71) Applicant: Michael A. McCoy, Schertz, TX (US)

(72) Inventor: Michael A. McCoy, Schertz, TX (US)

(21) Appl. No.: 17/589,269

(22) Filed: Jan. 31, 2022

Related U.S. Application Data
(60) Provisional application No. 63/207,213, filed on Feb. 16, 2021.

(51) Int. Cl. A47C 31/11

(52) U.S. Cl. CPC A47C 31/11

(57) ABSTRACT

The sauna seat 4 is three flat wooden pegs held together by three holes drill in the middle side of each peg holding it together, with sting like cable made of tough vinyl, which is heat resistance. The pegs are of the same wood that most conventional sauna are design with worldwide. The pegs can slide together enabling the seat to become a flat surface to sit on and thus making more room for other goers if necessary. It can be transported by any of the strings. The pegs are smooth to allow a towel place on top of the seat, if desired. It does not keep the towel dry from other sauna goers if exposed to.

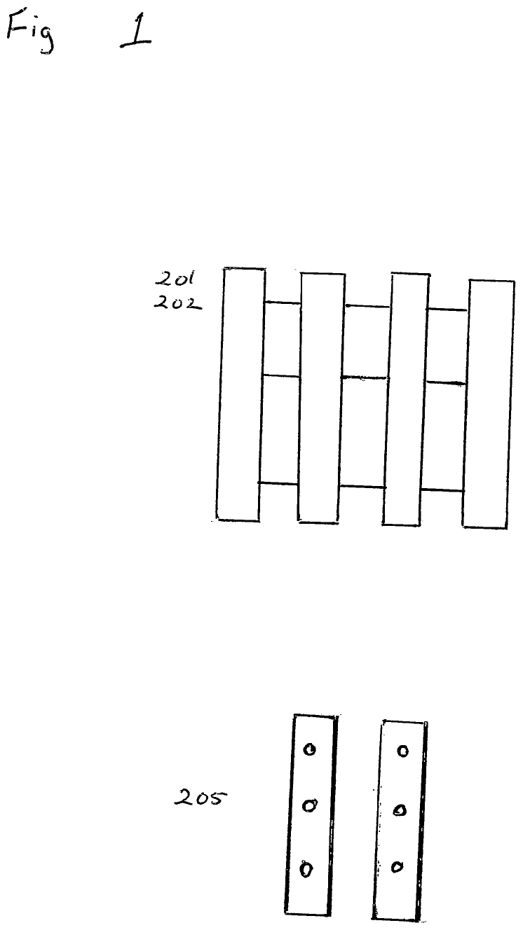

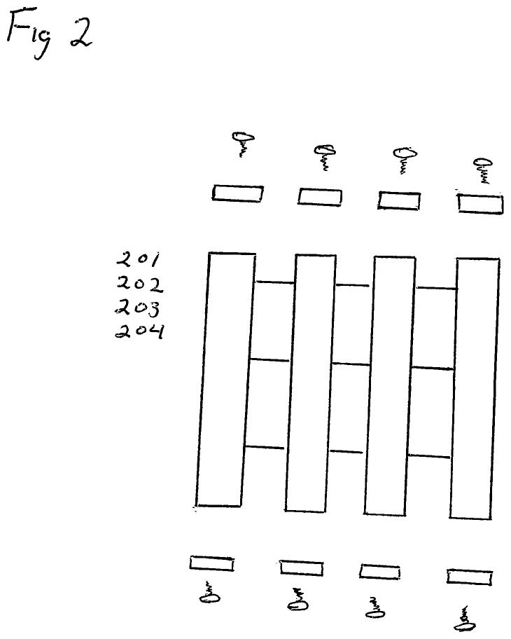

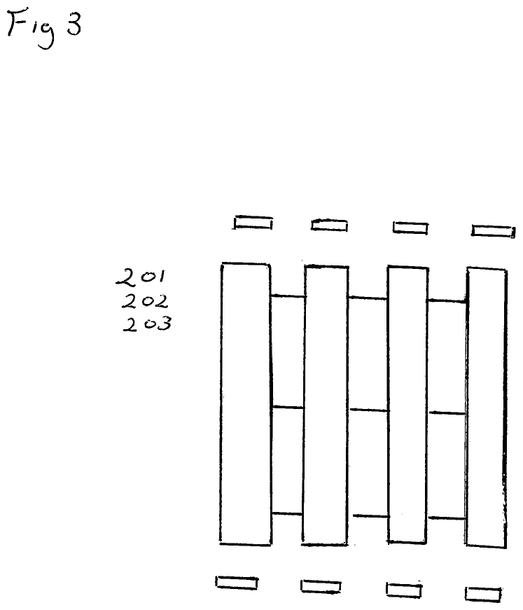

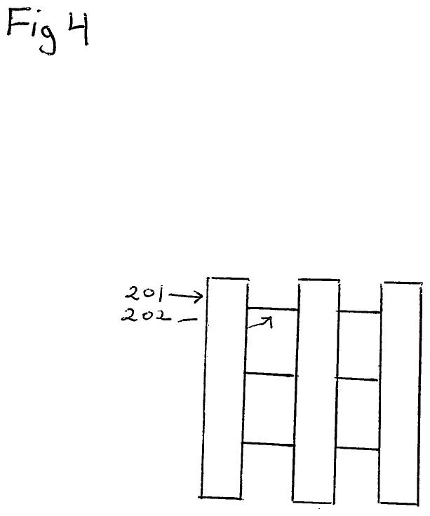

The sauna seat is made of cedar wood, same as most sauna and bamboo wood is also used for the seat.

It is held together with string like cable made of a fire resistance nylon material.

It consists of three, four or five wooden pegs whereas each peg has three holes drill in its side, the top, middle and bottom to be attached by the sting cable, thus making the seat collapsible, holes are a little more than one fourth of a inch in diameter. The pegs are about three inches wide

The pegs can be easily push together making it smaller for more room for other sauna goers.

The length of the pegs is 14 inches on model 4 for average sauna goers and model 1, 2, 3 is for slightly larger human being with the length of 15½.

The width when not push together is 16 inches and 7 inches when push together for model 1, 2, and 3.

The distance between the sauna bank in which a person sit on and sauna seat is 3¼ inches.

The string like cable can be used for easy transport.

Model 1

Sauna Seat 1 Four wooden pegs join together with string like cable, fire resistance nylon cable

Material Used
201 wooden pegs
202 string like cable
206 holes side view

Model 1 bottom part of drawing also show side view of all models with holes where the string like cable joins each peg to one another completing the seat

Model 3

Sauna Seat 3 has small blocks glued on the end of each of the four pegs join together with string like cable

Material Used
201 wooden pegs
202 sting like cable
204 1-inch-long small wooden blocks
Wood glue

Model 2

Sauna Seat 2 has ten small screws connecting the small blocks to both end of the five pegs and string like cable holding the pegs together as of like all the models

Material Used
201 wooden pegs
202 string like cable
204 1-inch-long small wooden blocks
205 small half inch screws

Patent for Model 4 Only

Model 4 Pattern

Sauna seat 4 three wooden pegs held together with string like cable fire resistance nylon cable

Material Used
201 wooden pegs
202 string like cable
206 holes side view

1. The sauna seat 4 is design to keep a sauna goer safe from sitting in another goers sweat and if used properly it does just that.
Top is where you place towel (label) thus minimizing the risk of contracting illnesses and the seat is easily clean.
Even when transporting by the string like cable, safety is still offered to the sauna goer.
